(19) United States
(12) Patent Application Publication
(10) Pub. No.: US 2020/0406589 A1
(43) Pub. Date: Dec. 31, 2020

(54) HEAT-INSULATING STRUCTURE

(71) Applicant: NAN YA PLASTICS CORPORATION, TAIPEI (TW)

(72) Inventors: TE-CHAO LIAO, TAIPEI (TW); Chia-Ho Cheng, TAIPEI (TW); CHUN-CHE TSAO, TAIPEI (TW)

(21) Appl. No.: 16/833,727

(22) Filed: Mar. 30, 2020

(30) Foreign Application Priority Data
Jun. 26, 2019 (TW) 108122251

(51) Int. Cl. B32B 17/10; C01G 41/00; C09J 7/38; B32B 7/12

(52) U.S. Cl. CPC B32B 17/10633; C01G 41/006; C09J 7/385; B32B 2307/304; B32B 2264/107; C01P 2004/64; B32B 2307/71; B32B 7/12

(57) ABSTRACT

A heat-insulating structure includes a substrate and an infrared blocking layer. The substrate has a first surface and a second surface opposite to the first surface. The infrared blocking layer is disposed on the first surface of the substrate and has a plurality of composite tungsten oxide particles uniformly distributed therein. Each of the composite tungsten oxide particles is doped with specific metal and non-metal elements, such that the infrared cut rate of the infrared blocking layer can reach 99%.

### CROSS-REFERENCE TO RELATED PATENT APPLICATION

This application claims the benefit of priority to Taiwan Patent Application No. 108122251, filed on Jun. 26, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a heat-insulating structure, and more particularly to a heat-insulating structure capable of being applied to various environments that require a balance between visibility and heat-insulating effect.

### BACKGROUND OF THE DISCLOSURE

Due to the influence of global warming, the demand for heat insulation and energy conservation tends to increase day by day. For example, when sunlight enters a room through glass windows, infrared radiation in sunlight may cause an increase in room temperature, and thus a ventilating or cooling device is needed to reduce discomfort from high room temperatures. According to statistical results, in summer time, solar radiation entering a room through its windows significantly increases the energy consumption of an air conditioner. It can be seen that the heat-insulating performance of the glass window would affect the room temperature of a building. Similarly, the heat-insulating performance of the glass window would also affect the room temperature of a vehicle.

The current common heat-insulating manner is to dispose a metal reflecting layer or a dyed layer on a target object. Although the metal reflecting layer can reflect infrared and ultraviolet, its related products may cause light damage. Although the dyed layer can absorb infrared, the heat-insulating performance thereof needs to be improved and may gradually fade. In addition, there is also a heat-insulating manner that uses a multilayered film structure formed by a metal plating layer and a dielectric layer. The multilayered film structure can allow the transmission of visible light and block infrared radiation by optical interference. However, said heat-insulating manner requires a large equipment investment and high material costs, and has a low product yield.

Since modern buildings employ a large number of glass windows and glass exterior designs, such as those adopting glass curtains, and since the use of cars has been quickly growing, the development of new high performance insulation materials has become a very important and urgent issue.

### SUMMARY OF THE DISCLOSURE

In response to the above-referenced technical inadequacies, the present disclosure provides a heat-insulating structure at least having a high visible light transmittance and a high infrared cut rate.

In one aspect, the present disclosure provides a heat-insulating structure which includes a substrate and an infrared blocking layer. The substrate has a first surface and a second surface opposite to the first surface. The infrared blocking layer is disposed on the first surface of the substrate and has a plurality of composite tungsten oxide particles uniformly distributed therein. The composite tungsten oxide particles have the following formula: CsₓMyWO_{3-z}N_{c}; Cs represents cesium; M represents tin (Sn), antimony (Sb) or bismuth (Bi); O represents oxide; N represents fluorine (F) or bromine (Br); x, y, z and c all are positive numbers and meet the following conditions: x≤1.0; y≤1.0; y/x≤1.0; z≤0.6; c≤0.1.

In certain embodiments, the average particle diameter of the composite tungsten oxide particles is between 10 nm and 90 nm, and the composite tungsten oxide particles are present in an amount between 5% and 25% by weight of the total weight of the infrared blocking layer.

In certain embodiments, the substrate has a thickness between 23 μm and 125 μm, and the infrared blocking layer has a thickness between 1 μm and 10 μm.

In certain embodiments, the substrate is formed from a polyester resin, and infrared blocking layer is formed from a material based on a UV-curable resin.

In certain embodiments, the heat-insulating structure further includes a bonding layer disposed on the second surface of the substrate.

In certain embodiments, the bonding layer has a UV-absorbing material therein.

In certain embodiments, the bonding layer has a thickness between 3 μm and 20 μm.

In certain embodiments, the bonding layer is formed from an acrylic based pressure sensitive adhesive.

In certain embodiments, the infrared blocking layer has a visible light transmittance of at least 70% in accordance with JIS K77025 standard and an infrared cut rate of at least 90% in accordance with JIS R3106 standard.

In one aspect, the present disclosure provides a heat-insulating structure which includes a first glass substrate, a second glass substrate and an infrared blocking layer. The first glass substrate and the second glass substrate correspond in position to each other. The infrared blocking layer is disposed between the first glass substrate and the second glass substrate and has a plurality of composite tungsten oxide particles uniformly distributed therein. The composite tungsten oxide particles have the following formula: CsₓMyWO_{3-z}N_{c}; Cs represents cesium; M represents tin (Sn), antimony (Sb) or bismuth (Bi); O represents oxide; N represents fluorine (F) or bromine (Br); x, y, z and c all are positive numbers and meet the following conditions: x≤1.0; y≤1.0; y/x≤1.0; z≤0.6; c≤0.1.

One of the advantages of the present disclosure is that the heat-insulating structure of the present disclosure can meet the application requirements of heat-dissipation products, including high heat insulation performance and sufficient visibility, by the technical solutions as follows: (1) the infrared blocking layer is disposed on the first surface of the substrate and has a plurality of composite tungsten oxide particles uniformly distributed therein, wherein each of the composite tungsten oxide particles is doped with specific metal and non-metal elements; and (2) the infrared blocking layer is disposed between the first glass substrate and the second glass substrate and has a plurality of composite tungsten oxide particles uniformly distributed therein, wherein each of the composite tungsten oxide particles is doped with specific metal and non-metal elements. The infrared blocking layer of the heat-insulating structure has a visible light transmittance of at least 70% and an infrared cut rate of at least 90%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a heat-insulating structure according to a first embodiment of the present disclosure.

FIG. 2 is another schematic view of the heat-insulating structure according to the first embodiment of the present disclosure.

FIG. 3 is a schematic view of a heat-insulating structure according to a second embodiment of the present disclosure.

FIG. 4 is another schematic view of the heat-insulating structure according to the second embodiment of the present disclosure.

FIG. 5 is a schematic view of a heat-insulating structure according to a third embodiment of the present disclosure.

FIG. 6 is another schematic view of the heat-insulating structure according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

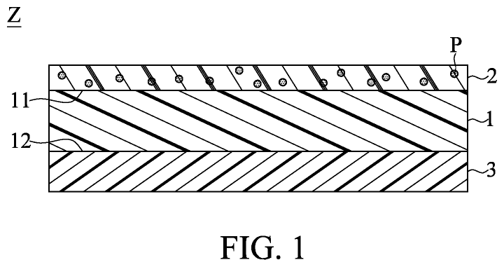

Referring to FIG. 1, a first embodiment of the present disclosure provides a heat-insulating structure Z which mainly includes a substrate 1 and an infrared blocking layer 2. The substrate 1 has a first surface 11 (e.g., top surface) and a second surface 12 (e.g., bottom surface) opposite to the first surface 11. The infrared blocking layer 2 is disposed on the first surface 11 of the substrate 1. The infrared blocking layer 2 has a plurality of composite tungsten oxide particles P uniformly distributed therein.

In use, the heat-insulating structure Z can be attached to a surface of a target object (not shown) that requires a balance between visibility and heat-insulating effect, so as to block infrared light and allow the transmission of visible light by the infrared blocking layer 2. The target object is, for example, a glass window or a glass facade of a building, a front or rear windshield, or a left side or right side window glass of a car. Therefore, a solar radiation effect on the indoor temperature can be reduced, thereby reducing energy consumption.

More specifically, the substrate 1 is used to transfer the infrared blocking layer 2 to the position where the target object is located. The substrate 1 has flexibility and can provide good support to the infrared blocking layer 2, such that the infrared blocking layer 2 can achieve a desired heat insulation effect. In the present embodiment, the substrate 1 is a plastic substrate having high transmittance that is preferably formed from a polyester resin. The thickness of the substrate 1 can be between 23 μm and 125 μm, and preferably between 23 μm and 75 μm. Examples of the material of the polyester resin include polyethylene terephthalate film (PET), polyethylene naphthalate (PEN), polyvinyl chloride (PVC), polycarbonate (PC), polypropylene (PP), polyethylene (PE) and nylon (Nylon). It should be noted that, in other embodiments, the substrate 1 can be a glass substrate and the thickness thereof can be changed according to particular requirements.

The infrared blocking layer 2 is in the form of a continuous layer, and mainly includes a plurality of composite tungsten oxide particles P and a molding resin. In practice, the composite tungsten oxide particles P can be dispersed in the molding resin to form a resin composition to be molding processed. In the present embodiments, the composite tungsten oxide particles P have the following formula: CsₓMyWO_{3-z}N_{c}; where Cs represents cesium, M represents tin (Sn), antimony (Sb) or bismuth (Bi), O represents oxide, and N represents fluorine (F) or bromine (Br); and x, y, z and c all are positive numbers and meet the following conditions: x≤1.0, y≤1.0, y/x≤1.0, z≤0.6, and c≤0.1. In addition, the molding resin can be a UV-curable resin, the examples of which include an acrylic resin and modified acrylic resins having different functional groups. It should be noted that, in other embodiments, the infrared blocking layer 2 can be in the form of a patterned layer according to particular requirements.

In consideration of the manufacture cost and heat insulation efficiency, the thickness of the infrared blocking layer 2 can be between 1 μm and 10 μm. Furthermore, the average particle size of the composite tungsten oxide particles P can be between 10 nm and 90 nm, and the composite tungsten oxide particles P are present in an amount between 5% and 25% by weight of the total weight of the infrared blocking layer 2. It should be noted that, the metal elements doped in the composite tungsten oxide particles P can make up for the deficiency of the infrared-absorbing ability of tungsten oxide, for example, increase the absorption of infrared light at a wavelength between 850 nm and 2500 nm. The metal elements doped in the composite tungsten oxide particles P can increase the weather resistance of the infrared blocking layer 2.

The infrared blocking layer 2 can be formed by the following steps:

Firstly, a heat-insulating particle dispersion (i.e., heat-insulating particle slurry) is prepared. The heat-insulating particle dispersion can include composite tungsten oxide particles P having the above formula, which are purchased from Nanya Plastics Compony, a solvent and a dispersing agent. The composite tungsten oxide particles P are uniformly dispersed in the solvent by the dispersing agent. According to particular requirements, by wet grinding, the composite tungsten oxide particles P can have a specific particle size and the heat-insulating particle dispersion can have a suitable viscosity that is between 50 cps and 200 cps.

The solvent can be a mixture of ethyl acetate, methyl ethyl ketone and propylene glycol monomethyl ether propionate. The dispersing agent may be at least one selected from anionic, nonionic and polymeric dispersing agents. The polymeric dispersing agent has anchoring group(s) such that it is a preferable selection for the dispersion. The anionic dispersing agent may be an acrylic-based anionic dispersing agent, the examples of which include ammonium polyacrylate (co)polymers, sodium polyacrylate (co)polymers, styrene-acrylic (co)polymers and sodium carboxylate copolymers. The examples of the nonionic dispersing agent include fatty alcohol ethoxyl compounds and polyoxyethylene alkyl ethers. The examples of the polymeric dispersing agent include polycarboxylates, sulfonic acid type polyester polyols, polyphosphates, polyurethanes and modified polyacrylate polymers. However, these are merely examples and not meant to limit the instant disclosure.

Next, the heat-insulating particle dispersion is mixed with a molding resin to form a resin composition to be processed into masterbatches. In this step, the heat-insulating particle dispersion can be mixed with raw material monomers of the molding resin, and subsequently a polymeric reaction among the raw material monomers is carried out under suitable reaction conditions (e.g., temperature, pressure, time and catalyst) to form the resin composition to be hot-melted, cooled and pelleted.

Lastly, the masterbatches are used in a molding process to form the infrared blocking layer 2. In this step, the masterbatches serving as the raw material is processed into a uniform and continuous film layer under suitable molding conditions (e.g., ultraviolet irradiation), and if necessary, the film layer can be post-processed (e.g., biaxially stretched) to have desired mechanical properties. It should be noted that, the infrared blocking layer 2 has a visible light transmittance of at least 70% in accordance with JIS K77025 standard and an infrared cut rate of at least 90% in accordance with JIS R3106 standard. In addition, the infrared blocking layer 2 has an excellent weather resistance.

Test of Visible Light Transmittance (VLT %):

A testing device (model name “TC-HIII DPK”, produced by Tokyo Denshoku Co., Ltd.) was used to test the visible light transmittance of the infrared blocking layer 2 in accordance with JIS K7705 standard. Therefore, the infrared blocking layer 2 has better transparency while it has high visible light transmittance.

Test of Infrared Cut Rate (IR Cut %):

A testing device (model name “LT-3000”, produced by HOYA) was used to test the infrared light transmittance of the infrared blocking layer 2 in accordance with JIS R3106 standard. The infrared cut rate of the infrared blocking layer 2 was obtained by subtracting its infrared light transmittance from 100%. Therefore, the infrared blocking layer 2 has better heat-insulating effect while it has high infrared cut rate.

Test of Weather Resistance:

A testing device (product of Atlas Material Testing Technology) is used in this test. The test conditions include a UVB wavelength of 313 nm, a temperature between 50° C. and 60° C., and a test time of 1000 hours. Each cycle includes irradiating the infrared blocking layer 2 with an irradiation energy of 0.71 W/m² for 4 hours and then steaming the infrared blocking layer 2 for 4 hours. After that, a spectrometer is used to measure the DE value of the infrared blocking layer 2, which indicates the level of color change. Therefore, the infrared blocking layer 2 has better weather resistance (e.g., light resistance) while it has a low DE value.

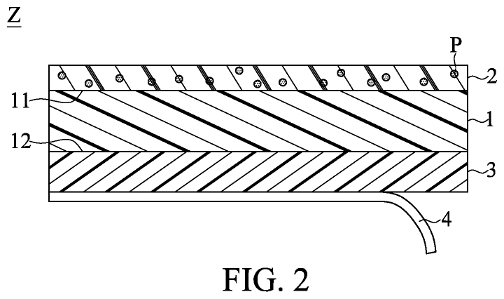

Referring to FIG. 2, the heat-insulating structure Z can further include a bonding layer 3 that is disposed on the second surface 12 of the substrate 2 and in the form of a continuous layer. In use, the heat-insulating structure Z can be attached to a target object by the bonding layer 3. In the present embodiment, the bonding layer 3 is formed from an acrylic based pressure sensitive adhesive, and the thickness thereof can be between 3 μm and 20 μm. Therefore, the bonding layer can provide an explosion-proof function. In addition, in consideration of usability, the bonding layer 3 can have on its surface a temporary cover layer 4 for preventing the surface from coming in contact with dirt, thereby preventing the decrease in bonding strength of the bonding layer 3. The temporary cover layer 4 can be removed from the surface of the bonding layer 3 before bonding to the target object. However, the material of the temporary cover layer 4 is not particularly limited insofar as the bonding layer 3 is stably attached to the surface of the bonding layer 3.

### Second Embodiment

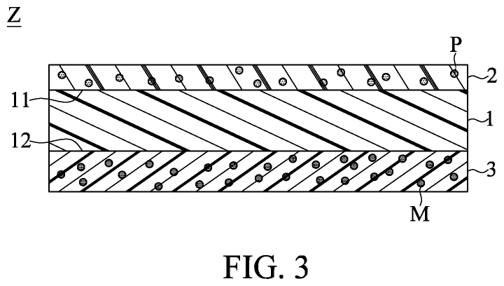

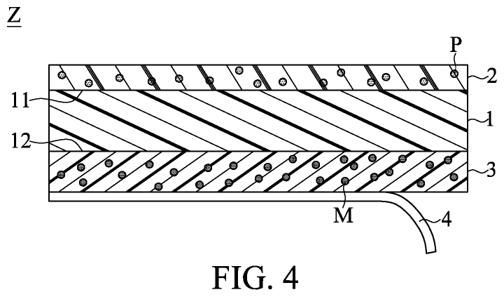

Referring to FIG. 3 and FIG. 4, a second embodiment of the present disclosure provides a heat-insulating structure Z which mainly includes a substrate 1, an infrared blocking layer 2 and a bonding layer 3. The substrate 1 has a first surface 11 and a second surface 12 opposite to the first surface 11. The infrared blocking layer 2 is disposed on the first surface 11 of the substrate 1. The infrared blocking layer 2 has a plurality of composite tungsten oxide particles P uniformly distributed therein. The bonding layer 3 is disposed on the second surface 12 of the substrate 1. The bonding layer 3 has a UV-absorbing material therein. Therefore, the heat-insulating structure Z can block ultraviolet.

The main difference between the present embodiment and the first embodiment is that the bonding layer 3 has a UV-absorbing material M therein. More specifically, the UV-absorbing material M can be mixed in an acrylic based pressure sensitive adhesive for molding processing, so as to form the bonding layer 3 having high ultraviolet blocking ability. The UV-absorbing material M may be at least one selected from nickel quenchers, oxalic anilines, benzotriazoles, benzoic acid esters, and benzophenones, but is not limited thereto. Other implementation details of the heat-insulating structure Z have been described in the first embodiment, and will not be reiterated herein.

### Third Embodiment

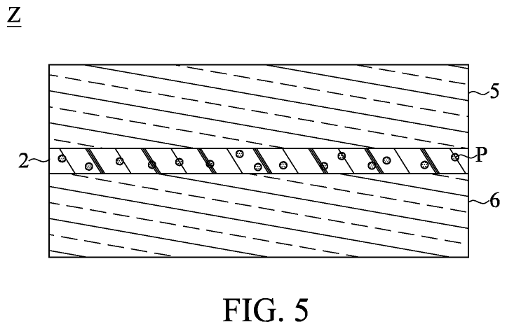

Referring to FIG. 5, a third embodiment of the present disclosure provides a heat-insulating structure Z which mainly includes a first glass substrate 5, a second glass substrate 6 and an infrared blocking layer 2. The first glass substrate 5 and the second glass substrate 6 correspond in position to each other. The infrared blocking layer 2 is disposed between the first glass substrate 5 and the second glass substrate 6, and has a plurality of composite tungsten oxide particles P uniformly distributed therein. The first glass substrate 5 and the second glass substrate 6 can each be a float glass or a tempered glass board, and the thickness thereof can be between 3 mm and 12 mm, but the present disclosure is not limited thereto. The technical details of the composite tungsten oxide particles P have been described in the first embodiment, and will not be reiterated herein.

In use, the first glass substrate 5 has an outer surface that is in an outdoor environment and is directly irradiated by sunlight, the second glass substrate 6 has an outer surface that is in an indoor environment, and the infrared blocking layer 2 is disposed between inner surfaces of the first glass substrate 5 and the second glass substrate 6. Accordingly, when sunlight irradiates the first glass substrate 5, infrared in the sunlight is difficult to pass through the infrared blocking layer 2 and transmitted to the second glass substrate 6. Therefore, a solar radiation effect on the indoor temperature can be reduced, thereby reducing energy consumption.

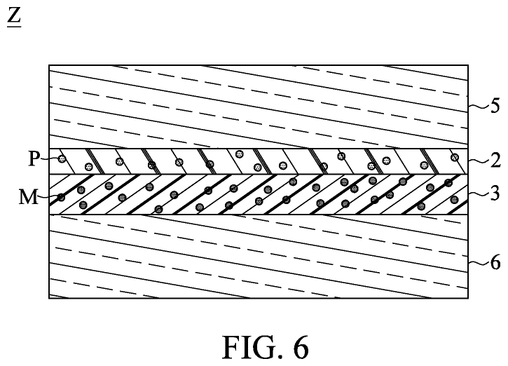

Referring to FIG. 6, the heat-insulating structure Z can further include a bonding layer 3 disposed between the first glass substrate 5 and the second glass substrate 6. The bonding layer 3 has a UV-absorbing material therein and is thus capable of blocking ultraviolet. The technical details of the bonding layer 3 have been described in the second embodiment, and will not be reiterated herein.

One of the advantages of the present disclosure is that the heat-insulating structure of the present disclosure can meet the application requirements of heat-dissipation products, including high heat insulation performance and sufficient visibility, by the technical solutions as follows: (1) the infrared blocking layer is disposed on the first surface of the substrate and has a plurality of composite tungsten oxide particles uniformly distributed therein, wherein each of the composite tungsten oxide particles is doped with specific metal and non-metal elements; and (2) the infrared blocking layer is disposed between the first glass substrate and the second glass substrate and has a plurality of composite tungsten oxide particles uniformly distributed therein, wherein each of the composite tungsten oxide particles is doped with specific metal and non-metal elements. The infrared blocking layer of the heat-insulating structure has a visible light transmittance of at least 70% and an infrared cut rate of at least 90%.

Furthermore, the heat-insulating structure further includes a bonding layer disposed on the second surface of the substrate. The bonding layer is formed from an acrylic based pressure sensitive adhesive and has a UV-absorbing material therein. Therefore, the heat-insulating structure has ultraviolet blocking and explosion-proof abilities in practical applications.

Based on the above, the heat-insulating structure of the present disclosure can reduce a solar radiation effect on the indoor temperature under strong sunlight, and thus contribute greatly to energy saving and carbon reduction.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A heat-insulating structure, comprising:
a substrate having a first surface and a second surface opposite to the first surface; and
an infrared blocking layer disposed on the first surface of the substrate and having a plurality of composite tungsten oxide particles uniformly distributed therein, the composite tungsten oxide particles having the following formula: CsₓMyWO_{3-z}N_{c};
wherein Cs represents cesium, M represents tin (Sn), antimony (Sb) or bismuth (Bi), O represents oxide, and N represents fluorine (F) or bromine (Br);
wherein x, y, z and c are all positive numbers and meet the following conditions: x≤1.0; y≤1.0; y/x≤1.0; z≤0.6; c≤0.1.

2. The heat-insulating structure according to claim 1, wherein the average particle diameter of the composite tungsten oxide particles is between 10 nm and 90 nm, and the composite tungsten oxide particles are present in an amount between 5% and 25% by weight of the total weight of the infrared blocking layer.

3. The heat-insulating structure according to claim 1, wherein the substrate has a thickness between 23 μm and 125 μm, and the infrared blocking layer has a thickness between 1 μm and 10 μm.

4. The heat-insulating structure according to claim 3, wherein the substrate is formed from a polyester resin, and the infrared blocking layer is formed from a material based on a UV-curable resin.

5. The heat-insulating structure according to claim 1, further comprising a bonding layer disposed on the second surface of the substrate.

6. The heat-insulating structure according to claim 5, wherein the bonding layer has a UV-absorbing material therein.

7. The heat-insulating structure according to claim 5, wherein the bonding layer has a thickness between 3 μm and 20 μm.

8. The heat-insulating structure according to claim 5, wherein the bonding layer is formed from an acrylic based pressure sensitive adhesive.

9. The heat-insulating structure according to claim 1, wherein the infrared blocking layer has a visible light transmittance of at least 70% in accordance with JIS K77025 standard and an infrared cut rate of at least 90% in accordance with JIS R3106 standard.

10. A heat-insulating structure, comprising:
a first glass substrate;
a second glass substrate corresponding in position to the first glass substrate; and
an infrared blocking layer disposed between the first glass substrate and the second glass substrate and having a plurality of composite tungsten oxide particles uniformly distributed therein, the composite tungsten oxide particles having the following formula: CsₓMyWO_{3-z}N_{c};
wherein Cs represents cesium, M represents tin (Sn), antimony (Sb) or bismuth (Bi), O represents oxide, and N represents fluorine (F) or bromine (Br);
wherein x, y, z and c all are positive numbers and meet the following conditions: x≤1.0; y≤1.0; y/x≤1.0; z≤0.6; c≤0.1.
